(19) United States
(12) Patent Application Publication
(10) Pub. No.: US 2026/0269960 A1
(43) Pub. Date: Sep. 10, 2026

(54) METHODS AND DEVICES FOR REPORTING SUBBAND VALUES OF L1-SINR, INTERFERENCE LEVEL, AND/OR L1- RSRP

(71) Applicant: Google LLC, MOUNTAIN VIEW, CA (US)

(72) Inventor: Yushu ZHANG, Beijing (CN)

(21) Appl. No.: 19/471,951

(22) PCT Filed: Apr. 7, 2023
(86) PCT No.: PCT/CN2023/086906

§ 371 Date: Oct. 2, 2025

(51) Int. Cl. H04B 17/318; H04B 7/06; H04L 5/00; H04L 27/26

(52) U.S. Cl. CPC H04B 17/328; H04B 7/0626; H04L 5/0044; H04L 27/261

(57) ABSTRACT

Methods and devices enable measuring downlink reference signals to report values of a subband layer 1 signal-to-interference plus noise, a subband interference level and/or a subband layer 1 reference signal received power, for each of at least two subbands. Selection of a modulation and coding scheme and a number of downlink transmission layers is enhanced by using the values. Assuming channel reciprocity, uplink sounding reference signals are also employed in the measuring and reporting subband values leading to this selection.

### FIELD OF THE DISCLOSURE

This document generally describes methods and devices operating in wireless communication systems such as (but not limited to) the ones described in 5G standard documents, known as 3GPP communication systems.

### BACKGROUND

According to current 5G standard documents, the network configures a UE to measure and to report quality of reference signals in a Channel State Information (CSI) report. The CSI report includes values of rank indicator (RI), precoder matrix indicator (PMI), channel quality indicator (CQI) and layer indicator (LI). The RI and PMI values are used to indicate the best digital precoder, CQI is used to indicate a signal-to-interference plus noise (SINR) status (i.e., quantized values) thus to facilitate selection of a modulation and coding scheme (MCS), and LI is used to identify the strongest layer for the reported precoder indicated by RI and PMI.

A network entity (NE) (i.e., a network device with a well-defined functionality such as a base station communicating with one or more UEs) may configure measurement and report granularity for the CQI and PMI. The NE may configure the UE to report wideband or subband CQI and/or subband PMI. The NE may configure a codebook for the RI and PMI report as Type1 codebook, Type2 codebook, eType2 codebook, and so on. The UE reports the CQI based on the precoder indicated by the reported RI and PMI, and measurements of channel state information reference signals (CSI-RSs).

In view of uplink-downlink channel reciprocity, the NE can estimate the downlink channel based on measurements of uplink sounding reference signals (SRSs). FIG. 1 shows scenario 100 in which NE 110 receives 101 SRSs from UE 120. The NE can configure the UE to transmit one or more than one set of SRSs for antenna switching. NE 110 uses the uplink channel quality based on the received SRSs to identify a precoder for downlink transmissions. For example, procedures for CSI report are described in 3GPP TS 38.214 section 5.2.2, procedures for SRS for downlink CSI acquisition are described in 3GPP TS 38.214 section 6.2.1.2, and RRC parameters for CSI report are described in 3GPP TS 38.331 section 6.3.2.

A received signal power γₖ at a UE on a downlink resource element (RE) k can be expressed as

$${Y}_{k} = {α H}_{k} {W}_{k} {X}_{k} + {N}_{k} \qquad ( 1 )$$

where α corresponds to the large scale received energy based on the slow fading, which is based on the coupling loss between the UE and NE, Hₖ corresponds to fast fading, which is based on the variation of the multi-path channel, at RE k, Wₖ corresponds to the digital precoder for RE k, Xₖ is the modulated symbol at RE k, Nₖ is the noise plus interference at RE k. Fading is the phenomenon of altering the signal's transmitted power Xₖ along a transmission medium or path.

In currently standardized UEs, the UE calculates CQI and RI based on a UE selected precoder, which could be different from the precoder that the network would select. Then, an open-loop link adaptation is employed (i.e., updating the modulation order and coding scheme based on the ACK/NACK status for PDSCH) for the selected signal processing phases (precoder, MCS, etc.) to converge.

In view of uplink/downlink channel reciprocity, the NE can estimate Hx for each subcarrier based on the received SRSs. Then, the NE can calculate channel's eigenvector/eigenvalues for selecting the digital precoder. However, the NE has no information on other factors including the slow fading (i.e., a), interference and noise level (i.e., Nₖ). Therefore, the NE can only identify the best direction and energy for the digital precoder, but cannot estimate the channel quality, so that it cannot necessarily determine the most appropriate rank of the precoder and cannot necessarily identify the most appropriate modulation and coding scheme (MCS) for the downlink transmission 102 in FIG. 1.

### SUMMARY

Methods and devices for subband signal-to-interference plus noise (SINR) report provide SINR status for subbands enabling downlink MCS and precoder selection in a channel reciprocity paradigm. The various embodiments reports values of subband layer 1 signal-to-interference plus noise (L1-SINR), subband interference level, or subband layer 1 reference signal received power (L1-RSRP) for plural subbands. These reports, enable the network to select MCS and number of layers for downlink transmission more accurately, which improves overall system's performance and reliability.

### BRIEF DESCRIPTION OF THE DRAWINGS

The accompanying drawings, which are incorporated in and constitute a part of the specification, illustrate one or more embodiments and, together with the description, explain these embodiments.

FIG. 1 illustrates a scenario in which a UE transmits SRSs for enabling an NE to configure UE's uplink transmissions.

FIG. 2 is a schematic diagram of a radio communication system in which various embodiments are implemented.

FIG. 3 is a signal diagram of a procedure for reporting values of subband L1-SINR, interference level and/or L1-RSRP according to an embodiment.

FIG. 4 is a flowchart illustrating UE behavior related to reporting values of subband L1-SINR, interference level and/or L1-RSRP according to an embodiment.

FIG. 5 is a flowchart illustrating NE behavior related to reporting values of subband L1-SINR, interference level and/or L1-RSRP according to an embodiment.

FIGS. 6A-6C are graphical illustrations of techniques for calculating values of subband L1-SINR according to various embodiments.

FIGS. 7A and 7B are graphical illustrations of DMRS-based SINR measurements according to some embodiments.

FIG. 8 is a flowchart of a method performed by a UE related to reporting values of subband L1-SINR, interference level and/or L1-RSRP according to an embodiment.

FIG. 9 is a flowchart of a method performed by a UE related to reporting values of subband L1-SINR, interference level and/or L1-RSRP according to an embodiment.

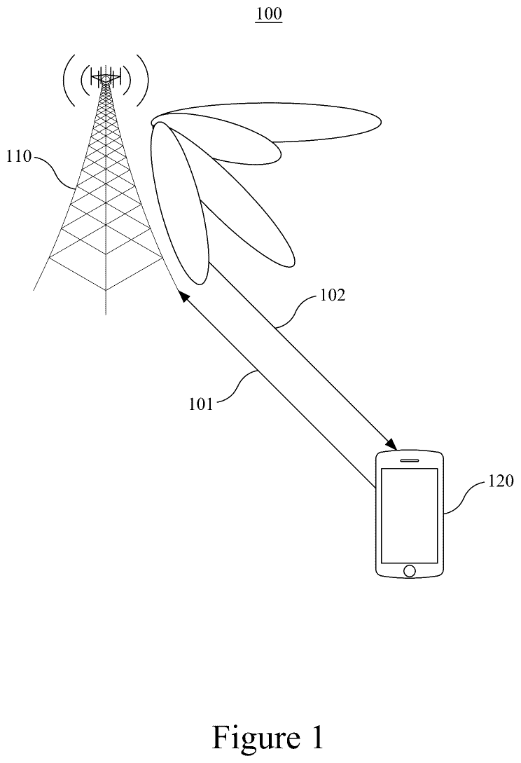

### DETAILED DESCRIPTION

Methods and devices described in this section embody techniques related to reporting values of subband L1-SINR, interference level, and/or L1-RSRP. Subband L1-SINR and interference level provide subband specific information about the noise plus interference (e.g., Σ_{k∈S}|Nₖ|² in formula 1, where S indicates the set of subcarriers in the subband) and/or subband L1-RSRP provides information on received signal power (e.gΣ_{k∈S}|αHₖ|2 in formula 1).

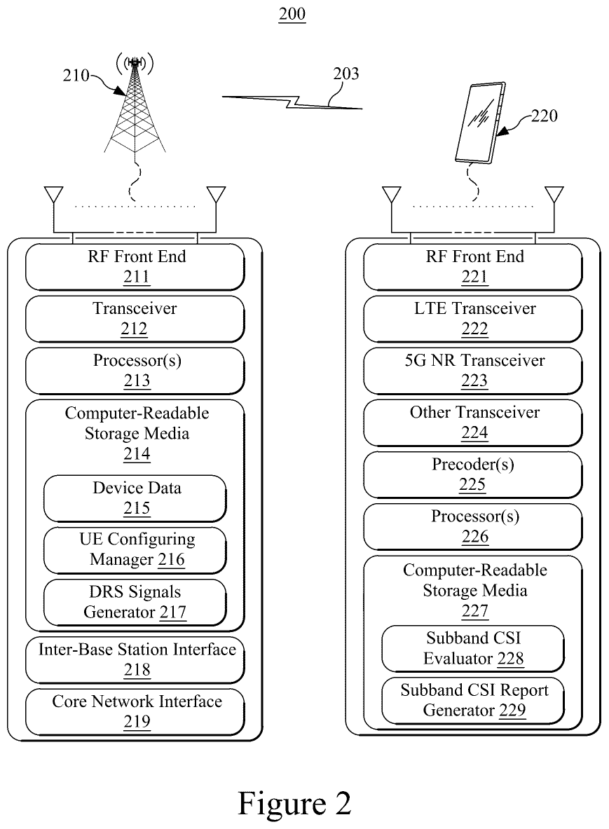

FIG. 2 is a schematic diagram of a radio communication system 200 including an NE 210 and a UE 220 that can implement various techniques related to reporting values of subband L1-SINR, interference level and/or L1-RSRP described in this section. An NE may be a base station, BS, but more generally, the term stands for a wireless device with a well-defined network functionality (e.g., BS's functionality is connecting UEs to the core network including managing communications to and from the UEs). NE 210 and UE 220 may include additional functions and interfaces omitted from FIG. 2 in the interest of brevity. Signaling arrow 203 generally represents both uplink and downlink signals transmitted by NE 210 and UE 220, respectively.

NE 210 as illustrated in FIG. 2 may provide the functionality of an gNB (i.e., a 5G or 6G base station). NE 210's functionality may be distributed across multiple entities (e.g., a central unit, CU, a distributed unit, DU, and a radio unit, RU). NE 210 includes antennas and an RF front end 211 and RF transceiver(s) 212 (there may be more transceivers for different technologies, as illustrated for UE 220) for communicating with UE 220 and other UEs and NEs. NE 210's antennas and RF front end 211 can be tuned to one or more frequency bands (e.g., subcarriers), for example as defined by 3GPP LTE, 5G NR, and 6G communication standards and implemented by RF transceiver(s) 212.

NE 210 includes processor(s) 213 and computer-readable storage media (CRM) 214. Processor(s) 213 can include single or multiple-core processors, and CRM 214 includes any suitable memory/storage except propagating signals. For example, memory/storage can include random-access memory (RAM), static RAM (SRAM), dynamic RAM (DRAM), non-volatile RAM (NVRAM), read-only memory (ROM), and/or flash memory. CRM 214 stores device data 215, which includes network scheduling data, radio resource management data, applications, and/or an operating system, which are executable by processor(s) 213 to enable wireless communication 203 with UE 220 as well as with other NEs and UEs.

CRM 214 also stores UE configuring manager 216 and downlink reference signals (DRS) signal generator 217. UE configuring manager 216 causes NE 210 to perform various steps and actions for generating configuration instructions directing UE 220 to measure DRSs for reporting values of a subband L1-SINR, a subband interference level, or a subband L1-RSRP, corresponding to UE subbands. DRS signal generator 217 transmits DRSs as indicated in the configuration instructions.

NE 210 also includes inter-base station interface 218 and core-network interface 219. Inter-base station interface 218 can be a standardized interface, such as an Xn and/or X2 interface, for exchanging user-plane and control-plane data with another NE (e.g., in case of a handover). Core-network interface 219 enables NE's user-plane data and control-plane information exchange with core network functions and/or entities.

UE 220 includes antennas connected to a radio frequency (RF) front end 221, and at least one RF transceiver (such as, an LTE transceiver 222, a 5G NR transceiver 223, or another transceiver 224) for communicating with NE 210. The antennas and the RF front end 221 can be tuned to one or more frequency bands (e.g., subcarriers), for example, as defined by 3GPP LTE, 5G NR, and 6G communication standards and implemented by respective transceivers. UE 220 also includes one or more precoders 225, one or more processor(s) 226, and computer-readable storage media (CRM) 227. Processor(s) 226 may be single or multiple-core processors, and CRM 227 includes any suitable memory/storage other than propagating signals. For example, memory/storage can include random-access memory (RAM), static RAM (SRAM), dynamic RAM (DRAM), non-volatile RAM (NVRAM), read-only memory (ROM), and/or flash memory useable to store subband SINR evaluator 228 and subband SINR report generator 229 implementing various techniques described in this document. Subband SINR evaluator 228 causes various steps and actions for obtaining values of subband SINR, subband interference level and/or subband L1-RSRP for UE subbands. Subbed SINR report generator 229 causes various steps and actions for the UE to generate the subband SINR report according to the configuration instructions received from NE 210. Subband SINR evaluator 228 and subband SINR report generator 229 may be implemented not only as software but also as hardware logic and/or circuitry.

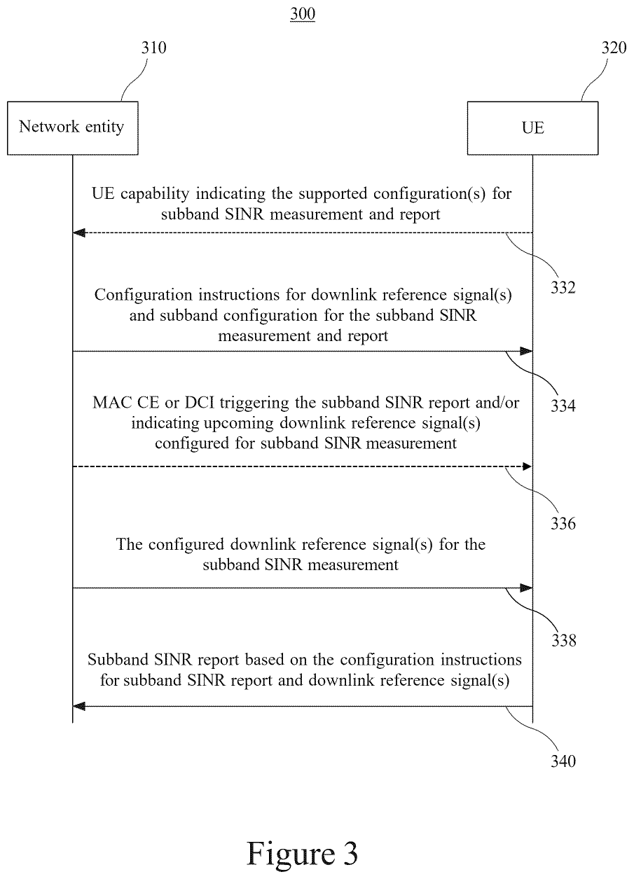

A wireless system such as the one schematically illustrated in FIG. 2 may implement various techniques related to subband SINR report as further described. FIG. 3 is a signal diagram of a procedure 300 for subband SINR report according to an embodiment. In some embodiments, UE 320 reports 332 UE's capability indicating UE supported configuration information including at least one of: (1) whether the UE supports subband L1-SINR report (i.e., obtaining and reporting values of subband L1-SINR), (2) whether the UE supports subband interference level report (i.e., obtaining and reporting values of subband interference level), (3) whether the UE supports subband L1-RSRP report (i.e., obtaining and reporting values of subband L1-RSRP), (4) the maximum number of configured DRSs for subband L1-SINR measurement and report per component carrier (CC) or across CCs in a band (i.e., a specific range of frequencies in the radio frequency (RF) spectrum), (5) the maximum number of configured DRSs for subband interference level measurement and report per CC or across CCs in a band, (6) the maximum number of configured DRSs for subband L1-RSRP measurement and report per CC or across CCs in a band, (7) the maximum number of configured downlink reference signals in a slot for subband L1-SINR measurement and report per component carrier (CC) or across CCs in a band, (8) the maximum number of configured downlink reference signals in a slot for subband interference level measurement and report per CC or across CCs in a band, and (9) the maximum number of configured downlink reference signals in a slot for subband L1-RSRP measurement and report per CC or across CCs in a band. Note that receiving this UE-supported configuration information is optional, the information may be obtained from another NE, for example, in case of a handover or from network's repository of capability information for registered UEs. Alternatively, the NE may assume default/nominal values for UE's capability.

Based on the UE capability, NE 310 configures 334 (i.e., provides, to the UE, configuration instructions related to) DRSs and UE subbands for the subband SINR report. In one embodiment, the NE configures the UE to generate a report including values of subband L1-SINR and another report including values of subband interference level and subband L1-RSRP. The NE may also provide configuration instructions for the DRSs to be used for determining the values, the subband configuration and configuration for the subband (e.g., the number of subbands and the number of physical resource blocks per subband). The NE may provide the configuration instructions via Radio Resource Control (RRC) signaling (e.g., RRCReconfiguration) or a Medium Access Control (MAC) Control Element (CE).

The NE may also transmit 336 a MAC CE or downlink control information (DCI) to trigger the subband SINR report and/or indicating upcoming DRS as configured for subband SINR measurement and report. In one example, the NE may transmit a MAC CE to activate the semi-persistent subband SINR report and/or semi-persistent DRSs for the subband SINR measurement and report. In another example, the NE may transmit a DCI to trigger the aperiodic subband SINR report and/or aperiodic downlink reference signals for the subband SINR measurement and report.

After receiving 338 the DRSs for subband SINR measurement and report, UE 320 transmits 340 the subband SINR to NE 310. The subband SINR may include one set of values indicating subband L1-SINR for UE subbands, or two sets of indicators, with the first set indicating the subband or wideband interference level and the second set indicating the subband or wideband L1-RSRP.

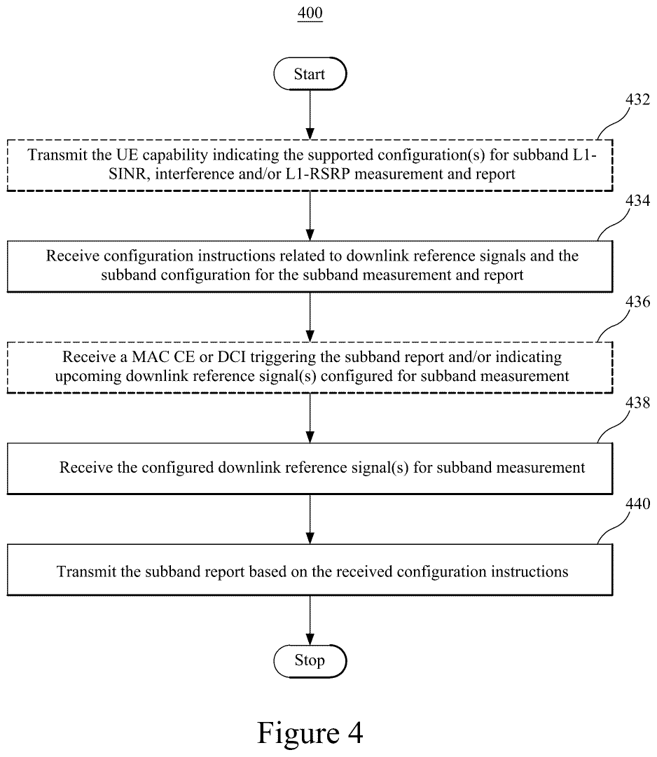

FIG. 4 illustrates a UE behavior related to the subband SINR report. The UE may transmit 432 a UE capability indicating UE supported configuration(s) (that is, UE-supported configuration information) for subband SINR measurement and report. The UE then receives 434 configuration instructions for measuring DRSs and subband configuration for the subband SINR measurement and report. Optionally, the UE may receive 436 a MAC CE or DCI triggering the subband SINR report and/or indicating upcoming DRS(s) as configured for SINR measurement and report. The UE then receives 438 the configured DRS(s) for subband SINR measurement and transmits 440 the subband SINR report based on the received configuration instructions.

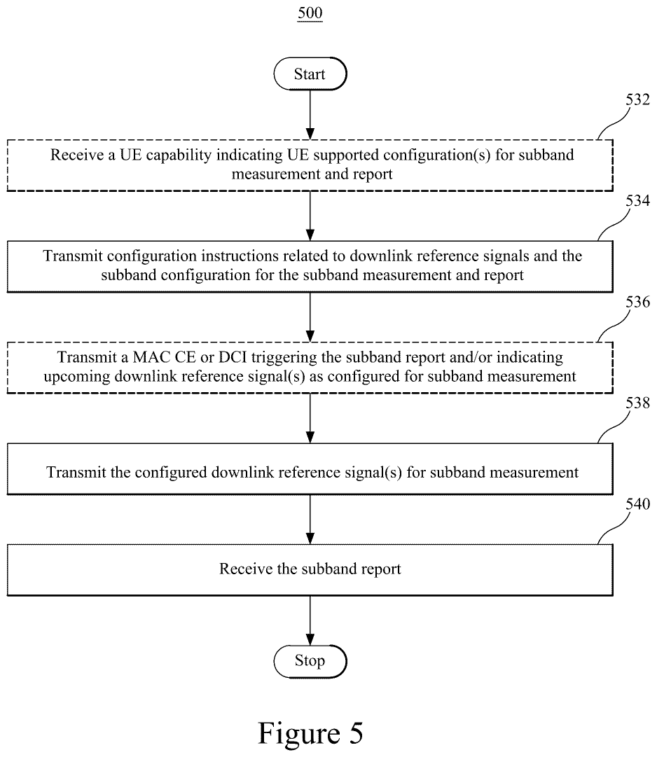

FIG. 5 illustrates an NE behavior related to subband SINR report. The NE may receive 532 a UE capability indicating UE supported configuration(s) (that is, UE-supported configuration information) for subband SINR measurement and report. The NE then transmits 532 configuration instructions for measuring DRSs and subband configuration for the subband SINR measurement and report. Optionally, the NE may also transmit a MAC CE or DCI for triggering the UE to generate the subband SINR report and/or indicating upcoming DRS(s) as configured for SINR measurement and report. The NE then transmits 338 the configured DRS(s) for subband SINR measurement and receives 440 the subband SINR report.

An RRC signaling usable to communicate the configuration instructions may be an RRC reconfiguration message from the NE to UE, or a system information block (SIB), where the SIB can be one of already defined SIBs (e.g., SIB1) or a new SIB (e.g., SIB J, where J is an integer above 21) transmitted by the NE. In some embodiments, the NE receives the one or more capabilities from a core network (e.g., Access and Mobility Management Function (AMF)). In yet some other embodiments, the NE receives the one or more capabilities from another base station (e.g., gNB or eNB).

Focusing first on subband L1-SINR report related features, in an embodiment, the NE configures the UE to report subband L1-SINR based on one or more than one downlink reference signals.

The values reported by the UE via the L1-SINR report may include (1) the absolute L1-SINR for each subband or (2) an absolute wideband L1-SINR value and differential L1-SINR values for each subband. In this latter case, the UE reports the subband L1-SINR using the wideband L1-SINR as a reference. The UE may report the differential subband L1-SINR with a smaller number of bits (e.g., 4) than the wideband L1-SINR (e.g., 8).

In some embodiments, the UE reports the subband L1-SINR and/or wideband L1-SINR in a short PUCCH (i.e., a PUCCH transmission with no more than 4 symbols). In some other embodiments, the UE reports the subband L1-SINR and/or wideband L1-SINR in a long PUCCH (i.e., a PUCCH transmission with more than 4 symbols). In some embodiments, the UE reports the subband L1-SINR and/or wideband L1-SINR in a PUSCH transmission.

Given a CSI Report framework (e.g., as described in 3GPP TS 38.214 section 5.2.1) including two parts (one for the configuration and the other for triggering states which are associated with a specific configuration), when reporting the subband L1-SINR and/or wideband L1-SINR in a long PUCCH or PUSCH transmission, the UE may report the subband L1-SINR values and the wideband L1-SINR value in a CSI part 1 or a CSI part 2. Alternatively, the UE may report the wideband L1-SINR value in a CSI part 1 and subband L1-SINR values in a CSI part 2.

Table 1 illustrates an example of reporting values of subband L1-SINR in a CSI part of one CSI report based on single downlink reference signal. Table 2 illustrates another example reporting values of subband L1-SINR in one CSI part of one CSI report based on one or more than one downlink reference signals configured as CMR selected from configured set of downlink reference signals configured as CMR.

TABLE 1
An example for subband L1-SINR report in one CSI part of
one CSI report based on single downlink reference signal

| | |
|---|---|
| CSI report x | Absolute wideband L1-SINR |
| | Absolute or differential L1-SINR for subband 1 |
| | Absolute or differential L1-SINR for subband 2 |
| | . . . |
| | Absolute or differential L1-SINR for subband N − 1 |
| | Absolute or differential L1-SINR for subband N |

TABLE 2
An example for subband L1-SINR report in one
CSI part of one CSI report with CMR selection

| | |
|---|---|
| CSI report x | CMR index 1 |
| | CMR index 2 |
| | . . . |
| | CMR index K |
| | Absolute wideband L1-SINR for CMR index 1 |
| | Absolute wideband L1-SINR for CMR index 2 |
| | . . . |
| | Absolute wideband L1-SINR for CMR index K |
| | Absolute or differential L1-SINR for subband 1 for CMR index 1 |
| | Absolute or differential L1-SINR for subband 2 for CMR index 1 |
| | . . . |
| | Absolute or differential L1-SINR for subband N for CMR index 1 |
| | Absolute or differential L1-SINR for subband 1 for CMR index 2 |
| | . . . |
| | Absolute or differential L1-SINR for subband N − 1 for CMR index K |
| | Absolute or differential L1-SINR for subband N for CMR index K |

If the UE measures the L1-SINR from more than one port of the downlink reference signal, the UE may report the L1-SINR with linear averaging from the antenna ports as equation (2):

$$γ = \frac{1}{{N}_{p}} {\sum }_{k = 1}^{{N}_{p}} {γ}_{k} \qquad ( 2 )$$

where γₖ indicates the linear L1-SINR measured from downlink reference signal port k; Ny indicates the total number of downlink reference signal ports used for L1-SINR measurement.

Alternatively, the UE may report the maximum or minimum L1-SINR measured from one of the antenna ports of the downlink reference signal as equation (3) and (4) respectively.

$$γ = max ( {γ}_{1} , {γ}_{2} , … , {γ}_{{N}_{p}} ) \qquad ( 3 )$$

$$γ = min ( {γ}_{1} , {γ}_{2} , … , {γ}_{{N}_{p}} ) \qquad ( 4 )$$

Alternatively, the UE may report the total L1-SINR measured across the antenna ports of the downlink reference signal as equation (5).

$$γ = {\sum }_{k = 1}^{{N}_{p}} {γ}_{k} \qquad ( 5 )$$

In another embodiment, the NE configures the UE to report a simplified subband channel quality indicator (CQI), where the UE may measure the CQI based on a fixed precoder, e.g., a precoder with antenna combining phase as 0 degree (i.e., the precoder is

$${\frac{1}{\sqrt{{N}_{p}}} [ {1}_{1} 1 , … , 1 , 1 ]}^{T} ,$$

where Nₚ is the number of ports for the downlink reference signal).

In another embodiment, the NE configures the UE to report the subband interference plus noise over signal ratio, which is

$$\frac{1}{λ} ,$$

whree λ is the linear L1-SINR.

Detailing now more CSI-RS based L1-SINR report, in an embodiment, the NE configures the UE to report subband L1-SINR based on one or more than one CSI-RS resources configured as channel measurement resource (CMR) and one or more than one interference measurement resource (IMR), e.g., CSI interference measurement (CSI-IM) and/or non-zero-power CSI-RS. Alternatively, the network entity configures the UE to report subband L1-SINR based on one or more than one CSI-RS resources. The UE measures both signal and interference from the configured CSI-RS resource(s).

Then the subband L1-SINR can provide the information of

$$\frac{{α}^{2}}{{σ}^{2}}$$

for each subband, where σ² indicates the interference plus noise power for the subband. With the L1-SINR and uplink channel derived from the SRS, the NE can determine the number of layers, which is used to determine the number of columns for the digital precoder Wand the MCS for the UE.

In some embodiments, the NE configures the frequency domain granularity for the L1-SINR report by RRC signaling, MAC CE or DCI. Thus, the NE may configure the UE to report wideband or subband L1-SINR, and the number of physical resource blocks (PRBs) per subband or a number of subbands.

In some other embodiments, the NE configures the UE to report L1-RSRP based on a wideband report or a subband report. The UE determines the number of subbands or the number of PRBs per subband based on the bandwidth for the CMR and/or IMR. For each number of scheduled PRBs, the number of subbands or the number of PRBs per subband may be predefined.

In some embodiments, the UE determines the subbands based on the bandwidth for the CMR. In some other embodiments, the UE determines the subbands based on the bandwidth for the IMR. In some other implementations, the UE determines the subbands based on the minimum or maximum or overlapped bandwidth for the CMR and IMR. In some other implementations, the network entity schedules the same bandwidth for the CMR and IMR. Thus, the network entity refrains from scheduling different bandwidth for the CMR and IMR.

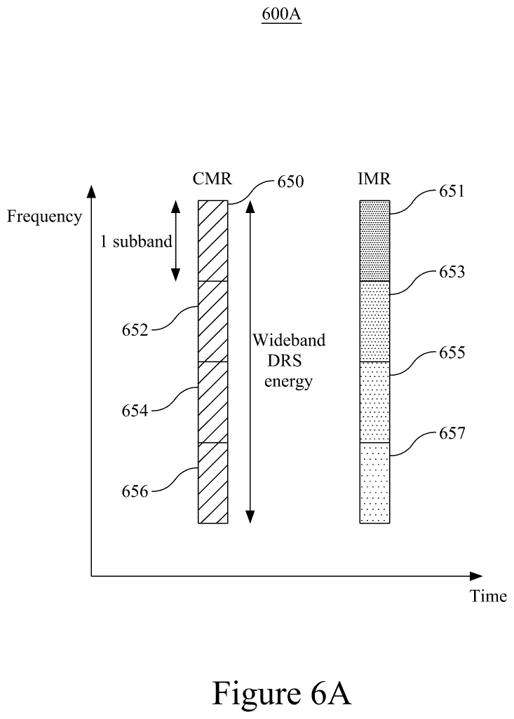

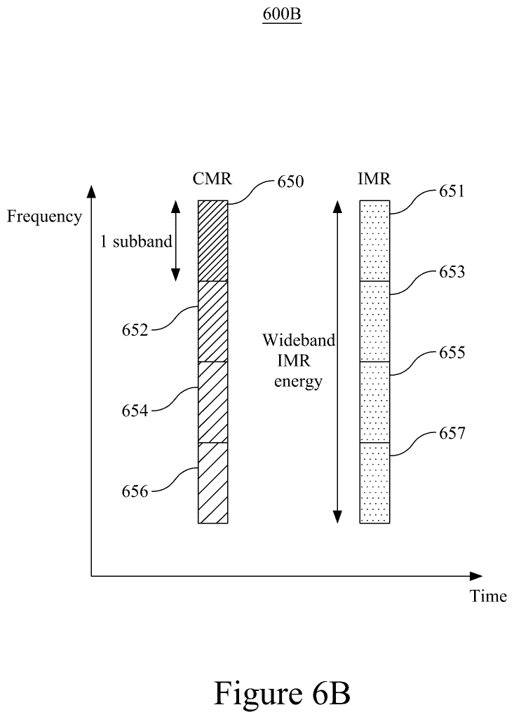

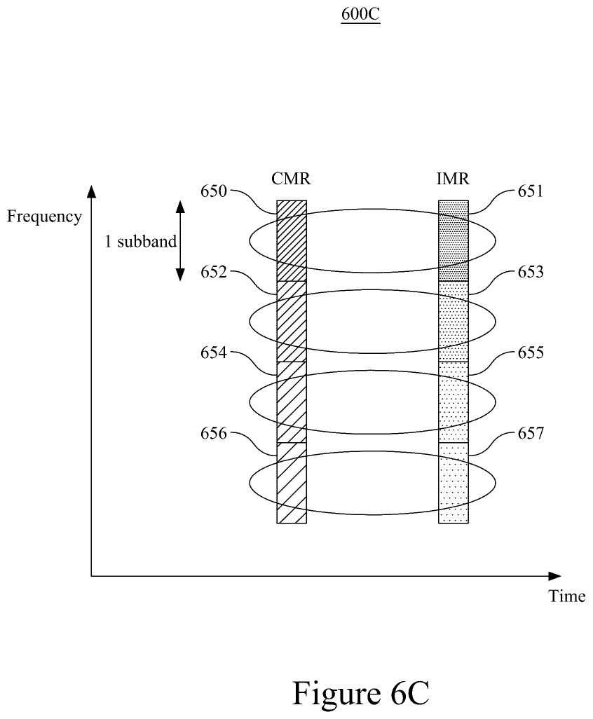

Graphic representations 600A, 600B and 600C in FIGS. 6A, 6B and 6C, respectively, illustrate (1) DRS (e.g., CSI-RS or DMRS) transmitted using configured measurement resources (CMR) 650, 652, 654 and 656, and (2) interference measurement resources (IMR) 651, 653, 655 and 657 spanning same equal width subbands. In the embodiment illustrated in FIG. 6A, the UE measures the subband L1-SINR based on the wideband channel from CMR and individual subband interference from IMR (that is, subband SINR=wideband channel energy/individual subband interference energy). In the embodiment illustrated in FIG. 6B, the UE measures the subband L1-SINR based on individual subband channel from respective CMR and wideband interference for all IMRs (that is, subband SINR=individual subband channel energy/wideband interference energy). In the embodiment illustrated in FIG. 6C, the UE measures the subband L1-SINR based on individual subband channel from CMR and individual subband interference from IMR, respectively (that is, subband SINR=individual subband channel energy/individual subband interference energy). In some other embodiments, the NE configures the subband L1-SINR measurement scheme (e.g., as in FIG. 6A, 6B, or 6C) for CMR and IMR measurement by RRC signaling, MAC CE or DCI. The UE may report the UE capability indicating the supported subband L1-SINR measurement scheme(s).

In some embodiments, the NE configures synchronization signal block (SSB) for obtaining values of subband L1-SINR. In some other embodiments, the NE refrains from configuring the SSB for obtaining values for subband L1-SINR, the NE then configuring the SSB for obtaining the wideband L1-SINR only.

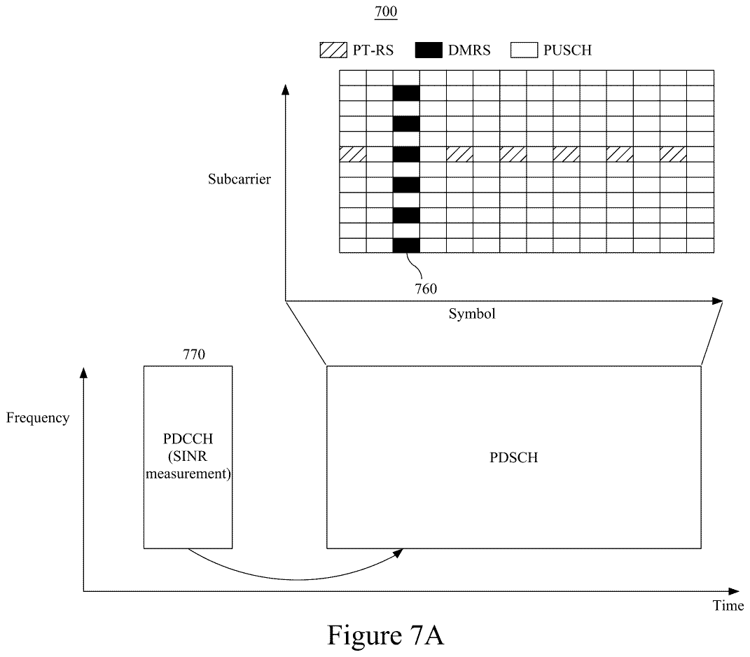

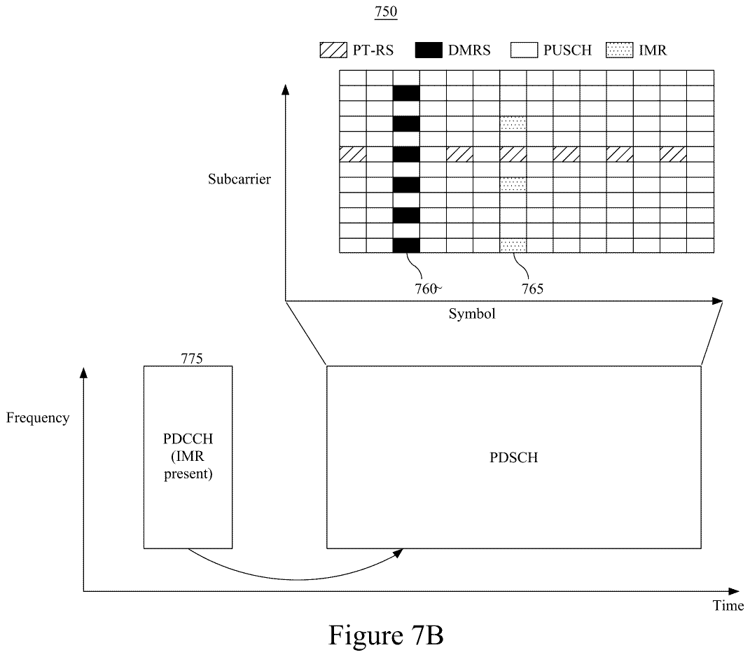

Turning now to demodulation reference signal (DMRS) based L1-SINR report, in an embodiment, the NE configures the UE to report subband L1-SINR based on DMRS of a physical downlink shared channel (PDSCH). The UE measures both signal and interference from the DMRS of the PDSCH as shown in FIG. 7A. That is, PDCCH 770 conveys directions for the UE to perform subband L1-SINR measurement and report using DMRS 760 only. In some other embodiments, the NE configures the UE to report subband L1-SINR based on DMRS of a physical downlink control channel (PDCCH).

Alternatively, the NE configures the UE to measure and report subband L1-SINR based on DMRS of a PDSCH and an IMR, e.g., CSI-IM and/or non-zero-power CSI-RS. The NE may configure the IMR resource by RRC signaling, MAC CE, or DCI. In one example, the network entity configures the time and frequency location in a slot for an IMR by RRC signaling and indicates whether the IMR is present or not associated with the PDSCH transmission. Then the REs used for the IMR are not to be used for the resource mapping of PDSCH, DMRS, and phase tracking reference signal (PT-RS) associated with the PDSCH as shown in FIG. 7B. That is, PDCCH 775 conveys directions for the UE to perform subband L1-SINR measurement and report using DRMS 760 and IM-RS 765.

In some embodiments, the UE reports the UE capability indicating whether the UE is able to obtain the values for subband L1-SINR based on DMRS of PDSCH or based on DMRS of PDSCH and IMR.

In some embodiments, the NE configures or indicates that the PDSCH is to be used for obtaining the values of subband L1-SINR via RRC signaling, MAC CE, or DCI. In one example, in the DCI scheduling the PDSCH, the network entity indicates whether the PDSCH is used for L1-SINR measurement or not.

In some other embodiments, the UE determines whether the PDSCH is used for subband L1-SINR measurement based on the indicated quasi-co-location (QCL) information or transmission configuration indicator (TCI) state for the PDSCH, and/or the bandwidth for the PDSCH. In one example, the UE may determine the PDSCH is used for subband L1-SINR measurement if the scheduled bandwidth for the PDSCH is above a threshold, where the threshold may be predefined, e.g., 20 resource blocks (RBs), or configured by the RRC signaling or MAC CE or DCI. In another example, the NE may configure the QCL or TCI state for the PDSCH based subband L1-SINR report, e.g., the QCL or TCI state that is the same as the SRS for downlink CSI acquisition, then the UE determines the PDSCH is used for L1-SINR measurement if the indicated QCL or TCI state for the PDSCH is the same as that is configured for subband L1-SINR report.

In some other embodiments, the NE triggers reporting values of the subband L1-SINR via the DCI used for the PDSCH scheduling. The UE then measures the subband L1-SINR based on the scheduled PDSCH. The NE may schedule the subband L1-SINR report and HARQ-ACK information report for the PDSCH by a common PUCCH resource. Alternatively, the NE may schedule the subband L1-SINR report and HARQ-ACK information report for the PDSCH by separate PUCCH resources.

In some other embodiments, the NE triggers the subband L1-SINR report and the PDSCH by separate DCIs. The NE may schedule a physical uplink shared channel (PUSCH) by the DCI used to trigger the subband L1-SINR report. The UE may report the subband L1-SINR via the scheduled PUSCH.

In some embodiments, the UE measures the subband L1-SINR from one or a subset of DMRS port(s). The subset of DMRS port(s) used for L1-SINR measurement may be predefined (e.g., the first 1 or 2 DMRS ports). Alternatively, the subset of DMRS port(s) used for L1-SINR measurement may be configured by the NE by RRC signaling, MAC CE or DCI. In some other embodiments, the UE may report the UE capability indicating the maximum number of DMRS ports that the UE supports for L1-SINR measurement.

Interference level and L1-RSRP may be reported jointly or separately. In an embodiment, the NE configures the UE to report the interference level and L1-RSRP based on one or more than one IMR and CSI-RS respectively. In some other embodiments, the NE configures the UE to report the interference level and L1-RSRP based on DMRS of a PDSCH, or IMR and DMRS of a PDSCH respectively. The UE measures the interference level based on the IMR(s) or DMRS of a PDSCH and the L1-RSRP based on the CSI-RSs or DMRS of a PDSCH. The NE may provide such configuration by RRC signaling, MAC CE or DCI.

In some embodiments, the network entity may configure the frequency domain granularity the interference level and/or L1-RSRP report. The NE may configure the UE to report wideband or subband interference level and/or L1-RSRP, and the number of PRBs per subband or number of subbands for the interference level and/or L1-RSRP respectively.

In some other embodiments, the NE configures the interference level and/or L1-RSRP report as a wideband report or a subband report. The UE determines the number of subbands or the number of PRBs per subband based on the bandwidth for the CMR and/or IMR. For each number of scheduled PRBs, the number of subbands or the number of PRBs per subband may be predefined.

In some embodiments, the NE configures the UE to report the interference level and L1-RSRP as uplink control information (UCI) in PUCCH or PUSCH. If the UE is configured to report the interference level and L1-RSRP by long PUCCH (i.e., a PUCCH transmission with more than 4 symbols) or PUSCH, the UE may report the interference level and L1-RSRP in a CSI part 1 or a CSI part 2. Alternatively, the UE may report the wideband interference level and wideband L1-RSRP in a CSI part 1 and subband interference level and subband L1-RSRP in a CSI part 2. The UE may report absolute interference level and absolute wideband L1-RSRP. The UE may report absolute or differential interference level and subband L1-RSRP. For differential interference level report, the UE determines the wideband interference level as the reference. For differential L1-RSRP report, the UE determines the wideband L1-RSRP as the reference.

In some other embodiments, the NE configures the UE to report the interference level and L1-RSRP via MAC CE. The UE may report subband interference level and subband L1-RSRP or the wideband interference level and L1-RSRP in addition to the subband interference level and L1-RSRP.

Table 3 illustrates an example for subband interference level and L1-RSRP report in one CSI part of one CSI report based on single downlink reference signal. Table 4 illustrates another example for subband interference level and L1-RSRP report in one CSI part of one CSI report based on one or more than one downlink reference signals configured as IMR/CMR selected from configured set of downlink reference signals configured as IMR/CMR. The network entity may configure the same number of CMRs and IMRs, where the CMR and IMR is one-to-one mapped.

TABLE 3
An example for subband interference level and
L1-RSRP report in one CSI part of one CSI report
based on single downlink reference signal

| | |
|---|---|
| CSI report x | Absolute wideband interference level |
| | Absolute wideband L1-RSRP |
| | Absolute or differential interference level for subband 1 |
| | Absolute or differential interference level for subband 2 |
| | . . . |
| | Absolute or differential interference level for subband |
| | N − 1 |
| | Absolute or differential interference level for subband N |
| | Absolute or differential L1-RSRP for subband 1 |
| | Absolute or differential L1-RSRP for subband 2 |
| | . . . |
| | Absolute or differential L1-RSRP for subband N − 1 |
| | Absolute or differential L1-RSRP for subband N |

TABLE 4
An example for subband interference level and L1-RSRP report
in one CSI part of one CSI report with CMR selection

| | |
|---|---|
| CSI report x | CMR/IMR index 1 |
| | CMR/IMR index 2 |
| | . . . |
| | CMR/IMR index K |
| | Absolute wideband interference level for CMR/IMR index |
| | 1 |
| | Absolute wideband interference level for CMR/IMR index |
| | 2 |
| | . . . |
| | Absolute wideband interference level for CMR/IMR index |
| | K |
| | Absolute wideband L1-RSRP for CMR/IMR index 1 |
| | Absolute wideband L1-RSRP for CMR/IMR index 2 |
| | . . . |
| | Absolute wideband L1-RSRP for CMR/IMR index K |
| | Absolute or differential interference level for subband 1 |
| | for CMR/IMR index 1 |
| | . . . |
| | Absolute or differential interference level for subband N |
| | for CMR/IMR index 1 |
| | Absolute or differential interference level for subband 1 |
| | for CMR/IMR index 2 |
| | . . . |
| | Absolute or differential interference level for subband |
| | N − 1 for CMR/IMR index K |
| | Absolute or differential interference level for subband N |
| | for CMR/IMR index K |
| | Absolute or differential L1-RSRP for subband 1 for CMR/ |
| | IMR index 1 |
| | . . . |
| | Absolute or differential L1-RSRP for subband N for CMR/ |
| | IMR index 1 |
| | Absolute or differential L1-RSRP for subband 1 for CMR/ |
| | IMR index 2 |
| | . . . |
| | Absolute or differential L1-RSRP for subband N − 1 for |
| | CMR/IMR index K |
| | Absolute or differential L1-RSRP for subband N for CMR/ |
| | IMR index K |

In some embodiments, the UE measures the subband L1-RSRP from one or a subset of DMRS ports. The subset of DMRS port(s) used for L1-RSRP measurement may be predefined, e.g., the first 1 or 2 DMRS ports. Alternatively, the subset of DMRS port(s) used for L1-RSRP measurement may be configured by the NE by RRC signaling, MAC CE, or DCI. In some other implementations, the UE may report the UE capability indicating the maximum number of DMRS ports that it can support for L1-RSRP measurement.

If the UE measures the L1-RSRP from more than one port of the downlink reference signal, the UE may report the L1-SINR with linear averaging from the antenna ports as equation (6).

$$β = \frac{1}{{N}_{p}} {\sum }_{k = 1}^{{N}_{p}} {β}_{k} \qquad ( 6 )$$

Alternatively, the UE may report the maximum or minimum L1-RSRP measured from one of the antenna ports of the DRS as equation (7) and (8), respectively. Alternatively, the UE may report the total L1-RSRP measured across the antenna ports of the DRS as equation (9).

$$β = max ( {β}_{1} , {β}_{2} , … , {β}_{{N}_{p}} ) \qquad ( 7 )$$

$$β = min ( {β}_{1} , {β}_{2} , … , {β}_{{N}_{p}} ) \qquad ( 8 )$$

$$β = {\sum }_{k = 1}^{{N}_{p}} {β}_{k} \qquad ( 9 )$$

where βₖ indicates the linear L1-RSRP measured from DRS port k and Ny indicates the total number of DRS ports used for L1-RSRP measurement.

In some embodiments, for a UE with more than one receiving antenna ports, the UE may measure interference level based on the maximum or minimum or average or total interference level received across the receiving antenna ports. In one example, the UE reports the interference level no less than the interference level received from any one of the receiving antenna ports (e.g., receiving branches).

In an embodiment, the NE configures the UE to report the interference level in a first report and to report the L1-RSRP in a second report. The NE may provide the configuration by RRC signaling or MAC CE. The NE may trigger the first or the second report by RRC signaling, MAC CE, or DCI. The NE may trigger both of the reports by a single signaling or separate signaling.

In some embodiments, the NE configures one or more than one IMR for the interference level report. The NE may configure the QCL or TCI state for the IMR by RRC signaling, MAC CE, or DCI. Alternatively, the NE triggers the IMR based on a DCI used to trigger a PDSCH. Then the UE receives the IMR based on the same QCL assumption used to receive the PDSCH. In some other embodiments, the NE configures the UE to measure the interference level based on the DMRS of a PDSCH or a CSI-RS. The NE may configure the frequency domain granularity for the interference level report. The NE may configure whether the UE should report wideband or subband interference level, and the number of PRBs per subband or number of subbands. The UE may report the subband interference levels. Alternatively, the UE may report absolute wideband interference level and absolute or differential subband interference levels.

In some embodiments, the NE configures one or more than one CSI-RS for the L1-RSRP report. In some other embodiments, the NE configures the UE to measure the L1-RSRP based on the DMRS of a PDSCH. The NE may configure the frequency domain granularity the L1-RSRP report. The NE may configure the UE to report wideband or subband L1-RSRP, and the number of PRBs per subband or the number of subbands. The UE may report the subband L1-RSRP or an absolute wideband L1-RSRP and absolute or differential subband L1-RSRP.

In some embodiments, the NE configures SSB for subband L1-RSRP report. In some other embodiments, the NE refrains from configuring the SSB for subband L1-RSRP report (i.e., the NE configures the SSB for wideband L1-RSRP report only).

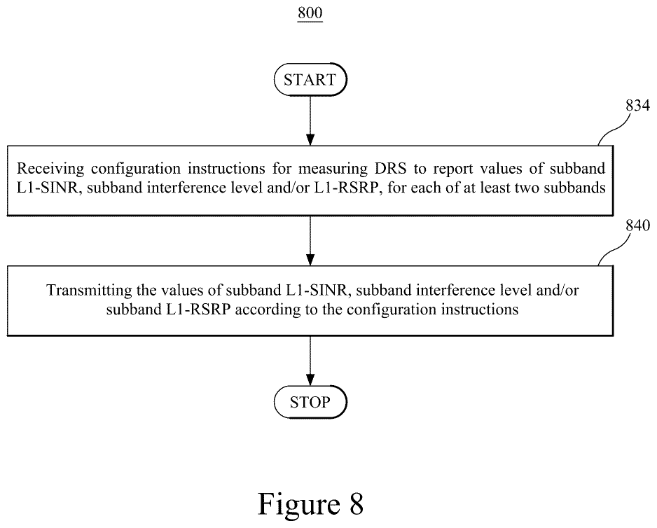

FIG. 8 is a flowchart of a method 800 performed by a UE related to reporting subband-related values according to an embodiment. Method 800 includes receiving configuration instructions for measuring DRS to report values of at least one of a subband L1-SINR, a subband interference level, or a subband L1-RSRP for each of at least two subbands. That is, a band allocated to the UE is divided into at least two subbands. The size and location of the subbands the UE needs to measure may be determined based on predefined specification and/or parameters specified via RRC configuration (for example as described in 3GPP TS 38.214 subsection 5.2.1.4).

Method 800 further includes transmitting the values of the at least one of the subband L1-SINR, the subband interference level, or a subband L1-RSRP for each of at least two subbands according to the configuration instructions.

The DRS used in method 800 may include CSI-RS or DMRS transmitted on PDSCH or DMRS transmitted on PDCCH. The configuration instructions may be included in a first control signal (e.g., RRC or MAC CE) indicating the DRS and a subband configuration, and a second control signal (e.g., MAC CE or DCI) triggering the UE to transmit the values in an aperiodic manner or a semipersistent manner, according to the configuration instructions.

Method 800 may further include transmitting a UE capability message comprising UE supported configuration information specifying UE's capability for obtaining the values of the subband L1-SINR, of the subband interference level and/or the L1-RSRP. Here, the UE-supported configuration information may indicate UE's ability to report the values of the subband L1-SINR, the values of the interference level and/or the values of the subband L1-RSRP as well as maximum DRS (optionally, in a slot) numbers for measuring these values per CC or across CC in a band.

The reported values may include an absolute wideband value and differential subband values. The reported values may be an average, a maximum or a minimum of antenna-specific measurements. The values of L1-SINR may be based on a DRS and CSI-IM and may be calculated as (1) a ratio of a subband energy of the DRS, and a wideband CSI-IM energy, (2) a ratio of a wideband energy of the DRS and a subband CSI-IM energy, or (3) a ratio of the subband energy of the DRS and the subband CSI-IM energy, as specified in the configuration instructions.

Method 800 may also include transmitting SRS prior to the receiving the configuration instructions, wherein the SRS and the vales enable a selection of an MCS and a number of downlink transmission layers.

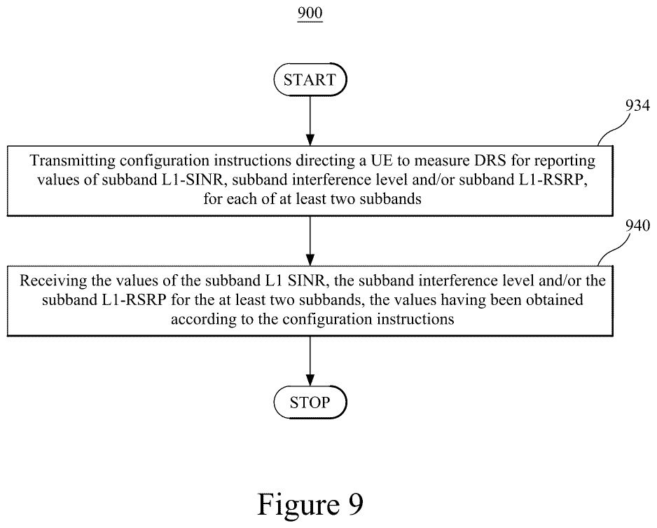

FIG. 9 is a flowchart of a method 900 performed by an NE related to reporting subband-related values according to an embodiment. Method 900 includes transmitting configuration instructions directing a UE to measure DRS for reporting values of at least one of a subband L1-SINR, a subband interference level, or a subband L1-RSRP corresponding to each of at least two subbands. Method 900 further includes receiving the values obtained according to the configuration instructions.

Method 900 may include receiving a UE capability message comprising UE-supported configuration information, wherein the configuration instructions are based on the UE-supported configuration information.

Method 900 may include transmitting downlink signals using an MCS and a number of downlink transmission layers selected using the values. The method may also include receiving SRS prior to transmitting the configuration instructions, and selecting the MCS and the number of downlink transmission layers based on the values and measurements of the SRS.

The embodiment descriptions in this section refer to the accompanying drawings. The same reference numbers in different drawings identify the same or similar elements. The detailed descriptions do preclude other embodiments within the scope of the appended claims. The embodiments are not limited to the described configurations but may be extended to other arrangements.

Reference throughout this section to “one embodiment” or “an embodiment” means that a particular feature, structure, or characteristic described in connection with an embodiment is included in at least one embodiment. Thus, the appearances of the phrases “in one embodiment” or “in an embodiment” in various places throughout the specification are not necessarily all referring to the same embodiment. Further, the particular features, structures or characteristics may be combined in any suitable manner in one or more embodiments.

Numerical adjectives “first”, “second”, and “third” do not imply any order (are not ordinals) but are markers to distinguish separate instances of similar elements. References to the singular (e.g., “a” or “an”, “the”) should include the plural unless clearly indicated otherwise.

Although the features and elements of the present embodiments are described in the embodiments in particular combinations, each feature or element can be used alone without the other features and elements of the embodiments or in various combinations with or without other features and elements disclosed herein. The methods or flowcharts may be implemented in a computer program, software or firmware tangibly embodied in a computer-readable storage medium for execution by a specifically programmed computer or processor.

1-17. (canceled)

18. A method performed by a user equipment (UE) operating in a wireless network, the method comprising:
receiving configuration instructions for measuring downlink reference signals (DRSs) to report values of at least one of
a subband layer 1 signal-to-interference plus noise (L1-SINR),
a subband interference level, or
a subband layer 1 reference signal received power (L1-RSRP), for each of at least two subbands; and
transmitting the values according to the configuration instructions.

19. The method of claim 18, wherein the DRSs include channel state information reference signals or demodulation reference signals of a physical downlink shared channel.

20. The method of claim 18, wherein the receiving the configuration instructions comprises:
receiving a first control signal indicating the DRSs and a subband configuration.

21. The method of claim 20, wherein the receiving the configuration instructions further comprises:
receiving a second control signal triggering the transmitting the values in an aperiodic manner or a semipersistent manner, according to the configuration instructions.

22. The method of claim 21, wherein the first control signal is included in a radio resource control message or a first a medium access control control element (MAC CE), and the second control message is included in a second MAC CE or a downlink control information message.

23. The method of claim 18, further comprising:
transmitting a UE capability message comprising UE supported configuration information specifying UE's capability for obtaining the values of the subband L1-SINR, the subband interference level, or the subband L1-RSRP.

24. The method of claim 22, wherein the UE supported configuration information indicates at least one of:
UE's ability to report the values of the subband L1-SINR;
UE's ability to report the values of the subband interference level;
UE's ability to report the values of the subband L1-RSRP;
a first maximum number of the DRS for the measuring the values of the subband L1-SINR, per component carrier (CC), or across CCs in a band;
a second maximum number of the DRS for the measuring the values of the subband interference level, per CC or across CCs in the band;
a third maximum number of the DRS for the measuring the values of the subband L1-RSRP, per CC or across CCs in the band;
a fourth maximum number of the DRS in a slot, for the measuring the values of the subband L1-SINR, per CC or across CCs in the band;
a fifth maximum number of the DRS in the slot, for the measuring the values of the subband interference level, per CC or across CCs in the band; or
a sixth maximum number of the DRS in the slot, for the measuring the values of the subband L1-RSRP, per CC or across CCs in the band.

25. The method of claim 18, wherein the values include at least one of:
an absolute wideband value of L1-SINR and differential values of the subband L1-SINR,
an absolute wideband value of interference level and differential values of the subband interference level, or
an absolute wideband value of L1-RSRP and differential values of the subband L1-RSRP.

26. The method of claim 18, further comprising:
transmitting sounding reference signals (SRSs) prior to the receiving the configuration instructions, wherein the SRSs and the values enable a selection of a modulation and coding scheme, and a number of downlink transmission layers.

27. The method of claim 18, wherein the values include L1-SINR values of subband L1-SINR based on the DRSs and channel state information interference measurement (CSI-IM) resources specified via the configuration instructions, each of the values of subband L1-SINR being calculated as
a ratio of a subband energy of the DRSs and a wideband CSI-IM energy;
a ratio of a wideband energy of the DRSs and a subband CSI-IM energy; or
a ratio of the subband energy of the DRSs and the subband CSI-IM energy, as specified in the configuration instructions.

28. The method of claim 18, wherein the values of the at least one of the subband L1-SINR, the subband interference level, or the subband L1-RSRP are an average, a maximum, or a minimum of antenna-specific values corresponding to the DRSs as measured by different UE antennas.

29. A user equipment (UE) comprising:
a transceiver; and
a processor coupled to the transceiver and configured to
receive configuration instructions for measuring downlink reference signals (DRSs) to report values of at least one of a subband layer 1 signal-to-interference plus noise (L1-SINR), a subband interference level, or a subband layer 1 reference signal received power (L1-RSRP), for each of at least two subbands; and
transmit the values according to the configuration instructions.

30. The UE of claim 29, wherein the DRSs include channel state information reference signals or demodulation reference signals of a physical downlink shared channel.

31. The UE of claim 29, wherein the processor is configured to receive the configuration instructions by:
receiving a first control signal indicating the DRSs and a subband configuration, and
receiving a second control signal triggering the transmitting the values in an aperiodic manner or a semipersistent manner, according to the configuration instructions.

32. The UE of claim 29, wherein the processor is configured to transmitting a UE capability message comprising UE supported configuration information indicates at least one of:
UE's ability to report the values of the subband L1-SINR;
UE's ability to report the values of the subband interference level;
UE's ability to report the values of the subband L1-RSRP;
a first maximum number of the DRS for the measuring the values of the subband L1-SINR, per component carrier (CC), or across CCs in a band;
a second maximum number of the DRS for the measuring the values of the subband interference level, per CC or across CCs in the band;
a third maximum number of the DRS for the measuring the values of the subband L1-RSRP, per CC or across CCs in the band;
a fourth maximum number of the DRS in a slot, for the measuring the values of the subband L1-SINR, per CC or across CCs in the band;
a fifth maximum number of the DRS in the slot, for the measuring the values of the subband interference level, per CC or across CCs in the band; or
a sixth maximum number of the DRS in the slot, for the measuring the values of the subband L1-RSRP, per CC or across CCs in the band.

33. A method performed by a network entity (NE) of a wireless network,
the method comprising:
transmitting configuration instructions directing a user equipment (UE) to measure downlink reference signals (DRSs) for reporting values of at least one of a subband layer 1 signal-to-interference plus noise (L1-SINR), a subband interference level, or a subband layer 1 reference signal received power (L1-RSRP), corresponding to each of at least two subbands; and
receiving the values obtained according to the configuration instructions.

34. The method of claim 33, further comprising:
receiving a UE capability message comprising UE-supported configuration information specifying UE's capability for obtaining the values of the subband L1-SINR, the subband interference level, or the subband L1-RSRP, wherein the configuration instructions are based on the UE-supported configuration information.

35. The method of claim 33, further comprising:
transmitting downlink signals using a modulation and coding scheme (MCS), and a number of downlink transmission layers selected based on the values.

36. The method of claim 35, further comprising:
receiving sounding reference signals, prior to the transmitting the configuration instructions; and
selecting the MCS and the number of downlink transmission layers using measurements of the sounding reference signals.

37. A wireless communication device comprising:
a transceiver; and
a processor coupled to the transceiver and configured to
transmit configuration instructions directing a user equipment to measure downlink reference signals for reporting values of at least one of a subband layer 1 signal-to-interference plus noise, a subband interference level, or a subband layer 1 reference signal received power, corresponding to each of at least two subbands; and
receive the values obtained according to the configuration instructions.
